(19) United States
(12) Patent Application Publication
(10) Pub. No.: US 2013/0015246 A1
(43) Pub. Date: Jan. 17, 2013

(54) SECURITY TAG, ASSEMBLY HAVING A SECURITY TAG, AND METHOD FOR OPERATION OF A SECURITY TAG

(71) Applicants: Guenther Galfe, Muenchen (DE); Reinhard Surkau, Traunstein (DE); Roland Groetzner, Unterschleissheim (DE); Helmut Schreiner, Muenchen (DE); Thomas Germann, Muenchen (DE)

(72) Inventors: Guenther Galfe, Muenchen (DE); Reinhard Surkau, Traunstein (DE); Roland Groetzner, Unterschleissheim (DE); Helmut Schreiner, Muenchen (DE); Thomas Germann, Muenchen (DE)

(73) Assignee: SCHREINER GROUP GMBH & CO. KG, Oberschleissheim (DE)

(21) Appl. No.: 13/575,097

(22) PCT Filed: Jan. 24, 2011
(86) PCT No.: PCT/EP11/50920

§ 371 Date: Sep. 27, 2012

(30) Foreign Application Priority Data
Jan. 26, 2010 (DE) 10 2010 005 714.2

(51) Int. Cl. G06K 19/077; B23P 11/00

(52) U.S. Cl. 235/488; 235/492; 29/428

(57) ABSTRACT

The invention relates to a security tag comprising a substrate layer (10), a void structure (20) applied to the substrate layer and an RFID transponder. The RFID transponder comprises at least one semiconductor chip (43) and a dipole antenna (30) which is applied above the void structure (20). According to the invention, upon triggering the void effect, the dipole antenna (30) is interrupted, which can be determined by a reduced reading range of the transponder. A manipulation attempt on the security tag can thus be determined.

### FIELD OF THE INVENTION

The invention relates to a security tag that can be affixed to objects and is equipped with an RFID transponder. The invention furthermore relates to an assembly that combines the security tag with other elements, as well as to a method for operation of a security tag, in which the latter is affixed to a body.

### BACKGROUND OF THE INVENTION

Tags that are affixed to a body are commonly used as luggage tags for identification in logistics processes, for example in the handling of travel luggage at an airport. The tags are delivered as elongated bands, passed around the handle of a piece of luggage by the handling personnel, and glued together at both free ends. The logistics information is imprinted on the band optically in the form of alphanumeric symbols and/or a barcode, on site. Furthermore, bands having RFID transponders are also in use, whose information can be read electronically, without making contact. The problem is that bands can unintentionally come loose from the piece of luggage, or could be intentionally taken off the piece of luggage and affixed to a different piece of luggage. It is supposed to be possible to determine a malfunction or misuse.

For this reason, a security tag that is as secure against manipulation as possible is desirable, in which a manipulation attempt, for example removal from the piece of luggage to which it was attached, can be recognized in relatively simple manner.

A security tag according to an embodiment of the invention comprises a substrate layer, a void structure applied to the substrate layer, and an RFID transponder applied above the void structure, which comprises at least one semiconductor chip and a dipole antenna.

According to the embodiment, the antenna can have a longitudinal expanse, in the case of the security tag, and the void structure can have multiple elements disposed next to one another at a distance, and, if applicable, a top layer that is applied above the elements of the void structure and contacts the substrate layer between the elements of the void structure. The dipole antenna contacts the top layer.

According to the embodiment, the void structure has specific adhesion conditions between the layers and/or the dipole antenna, and the substrate, so that after the ends of the security tag have been glued to one another, subsequent removal can be determined by making a void effect visible. For this purpose, an adhesion force between one of the elements of the void structure and the substrate layer is configured to be lower than an adhesion force between the dipole antenna and the adhesive. The aforementioned adhesion forces in turn are lower than an adhesion force between the dipole antenna and the top layer or an adhesion force between the top layer and the substrate layer or an adhesion force between the top layer and one of the elements of the void structure.

In this way, in the case of a manipulation attempt, in which the glued ends of the band are removed from one another, the result is achieved that parts of the top layer and of the antenna adhere partly to the substrate layer and partly to the adhesive layer, due to the different adhesion forces or adhesion forces. In particular, the elements of the void structure remain adhering to the antenna, while those parts of the antenna that are positioned between the elements of the void structure remain connected with the substrate layer and/or the parts of the top layer of the void structure that are directly connected with the substrate layer. This has the consequence that the antenna is interrupted. A read-out of the RFID transponder is now possible only with difficulty, or not at all, because the electrical conditions have changed due to the damaged antenna. For example, the reading range is reduced. Optically, the adhesion of the elements of the void structure, parts of the top layer, and parts of the dipole antenna to the various parts of the band can be recognized as a void effect. Experience has shown that it is no longer possible to glue the band together again in the correct position. Even if this were to succeed, a read-out of the RFID transponder would only be possible with difficulty because of the reduced range, and therefore could be determined.

According to embodiments, a semiconductor chip of the RFID transponder can be contacted with a loop antenna, which in turn stands in interaction with the elongated dipole antenna by means of an essentially magnetic active field. The RFID transponder can comprise a further semiconductor chip, which is coupled with the dipole antenna by means of a further loop antenna. If a dipole antenna is destroyed as the result of a manipulation attempt, it can be determined that access to the different semiconductor chips is possible only with a different reading range.

In other embodiments, multiple semiconductor chips of the RFID transponder can be connected to the dipole antenna by way of an adaptation network in place of a loop antenna. The semiconductor chips can store data, in each instance, which depend on the data that are stored in other semiconductor chips, in each instance, and/or make reference to them. A plurality of semiconductor chips can be disposed distributed along the dipole antenna, and can be electrically and/or magnetically coupled with it, whereby the distance between the semiconductor chips amounts to approximately λ/4 (λ=wavelength of the operating frequency).

According to an embodiment, placement of the security tag on a body comprises the security tag, which is wound around the circumference surface of the body. It is practical if that part of the security tag in which the one or the multiple semiconductor chips of the security tag are situated is dimensioned in such a manner that it lies on the circumference surface of the body, so that other parts of the security tag can be glued to one another, at least in part. In the case of a manipulation attempt, the dipole antenna would then be destroyed at an outer part, so that non-symmetry occurs in the RFID transponder, and access to the one semiconductor chip is made more difficult, or, in the case of access to the multiple semiconductor chips, a different reading range results. At least one-third of the length of the dipole antenna should be wound onto the body.

Another embodiment relates to a method for operation of a security tag, in which a means of identification is attached to a body. The means of identification has optically readable information and is, for example, another tag that is imprinted with alphanumeric and/or barcode information. The security tag is also wound onto the body and glued together at the ends, whereby information that is dependent on the optically readable information or is identical to the optically readable information is programmed into the semiconductor chip of the security tag. If the glued connection of the security tag is released and the dipole antenna is interrupted due to the void effect, a different maximal distance between the security tag and the reader device results, at which the programmed information from the semiconductor chip of the security tag is just barely readable. In the interrupted state, this maximal distance (reading range) is two to ten times less, preferably five to ten times less, than in the non-interrupted, fully functional state.

This means that an intact security tag can be reliably read out from a significantly greater reading range, so that therefore the optically readable information is comparable with the information stored electronically in the RFID transponder, while in the case of a manipulated security tag and therefore a destroyed dipole antenna, defective information or even no information can be read out of the semiconductor chip of the RFID transponder at the same distance from the reader device, so that the comparison with the information that continues to be optically readable is no longer successful.

### BRIEF DESCRIPTION OF THE DRAWINGS

In the following, the aforementioned embodiments and the invention will be explained in greater detail using the figures shown in the drawing. The same elements or elements that correspond to one another, in different figures, are provided with the same reference symbols. The drawing shows:

FIG. 1 a band according to one embodiment;

FIG. 2 a side view of the band from FIG. 1;

FIG. 3 another embodiment of a band in a side view;

FIG. 4 an enlarged detail of the band in the side view of FIG. 2;

FIG. 5 a band according to another embodiment;

FIG. 6 a band according to yet another embodiment;

FIG. 7 a band according to yet another embodiment;

FIG. 8 a band according to an embodiment having a plurality of semiconductor chips in the RFID transponder; and

FIG. 9 a band according to FIG. 1, wound up onto a round body.

### DETAILED DESCRIPTION OF EMBODIMENTS

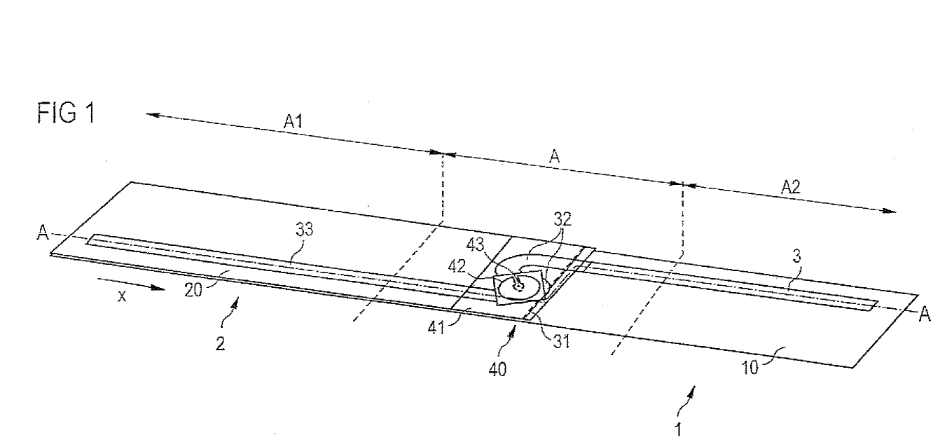

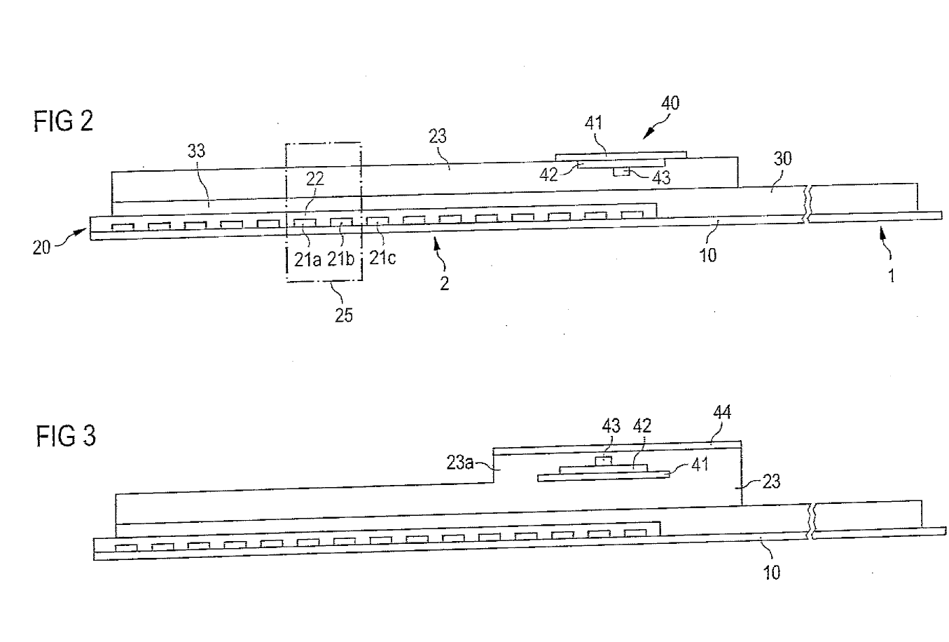

The embodiment shown in FIGS. 1 and 2 shows a security tag in the form of a band, before it is used as intended, in a top view and from the side, respectively, in longitudinal section along the section line A-A. The band shown comprises a section 2 as well as a section 1 that is complementary to the former. In section 2, a void structure is situated, while this void structure is absent and is not present in section 1. It is possible, in another embodiment (not shown), to apply the void structure over the full area of the entire course of the band substrate. The dipole antenna then contacts the void structure along the entire band. Furthermore, it is possible, in the case of this embodiment, to have the void structure become active only in the region provided with adhesive, with a void effect, in the event of subsequent loosening of the adhesive connection.

The band furthermore contains an RFID transponder from which an antenna 30 in the form of a dipole antenna extends almost along the entire length of the band (RFID: Radio Frequency Identification). In the regions of the dipole antenna 30 shown on the right and left in FIG. 1, this antenna runs outside the center of the band, in each instance, close to and parallel to the longitudinal edge and the longitudinal expanse direction x. Approximately in the central region of the band, seen over the length of the band, the dipole antenna changes its side position, so that when the band is attached to a body, in that the right and the left end of the band are glued together, a surface is enclosed by the two sections of the dipole antenna, in order to allow electromagnetic reception and emission and.

In this central region, the dipole antenna has a sort of S shape 32. This is where the semiconductor chip of the transponder is situated, which is coupled, in this embodiment, as will be explained below, to the dipole antenna having a secondary effect, by means of a primary loop antenna. The semiconductor chip with the primary loop antenna is made available in the form of a transponder inlay 40, during production of the band, and is inserted in the region of the S shape 32 of the dipole antenna, in such a manner that it lies within a U-shaped section 31 of the dipole antenna.

In the section 2 of the band shown on the left in FIG. 1, dipole antenna 33 and transponder inlay 40 are disposed above the void structure 20. In the remaining part 1 of the band, which is shown on the right in FIG. 1, the dipole antenna is applied directly to the band substrate 10, whereby a void structure between dipole antenna 30 and band substrate 10 is absent. The section 2 extends at least up to half the entire length in the direction x of the band. In the other stated embodiment, the void structure is applied to the entire band substrate and extends equally over the two sections 1 and 2 shown.

The transponder inlay 40 specifically comprises the semiconductor chip 43, which is disposed in the center of a primary loop antenna 42 that is configured as a circular-segment-shaped coil, and is electrically coupled with this primary loop antenna. The primary loop antenna is produced, for example, by means of etching or punching from a conductive layer, or by means of printing technology, from a conductive printable paste or a conductive printing ink. The circular-segment-shaped primary loop antenna is superimposed on an arc-shaped, for example a U-shaped part 31 in the changing section 32 of the dipole antenna, in order to exchange an active field with the dipole antenna, by means of electromagnetic, essentially magnetic coupling.

According to the usual functions of a transponder oscillating circuit, electromagnetic energy is absorbed by the dipole antenna from an external electromagnetic field, during operation, so that the antenna oscillates at an inherent frequency. The oscillation excited in the dipole antenna is transmitted to the circular-shaped primary loop antenna 42, by way of the U-shaped loop 31 of the dipole antenna, by means of magnetic coupling. The semiconductor chip 43 obtains its operating voltage from this, by means of rectification, and recognizes the signals modulated onto the external alternating field. In the reverse direction, data transmission from the semiconductor chip, by way of primary loop antenna and secondary dipole antenna, can also be given off to the surroundings, in which it is detected by a reader device located in the vicinity. The transponder inlay 40 is made available pre-assembled, for example, and is connected with the remaining structures, which are applied to the band substrate 10 by means of printing technology, for example. Optionally, a chip region covering 41 can be applied above the transponder inlay 40.

The void structure 20 will be explained in greater detail using the cross-section shown in FIG. 2. The void structure 20 comprises elements 21a, 21b, 21c applied directly to the band substrate 10, which run into the plane of the drawing, at a distance from one another on the band substrate 10. The elements 21a, 21b, 21c, of which a plurality of such are present in the region of the surface area of the void structure, in turn run parallel to one another, for example, and slightly diagonal to the longitudinal expanse direction x of the band. Because the corresponding section of the dipole antenna also runs parallel to the longitudinal direction x of the band in the region of the void structure 20, the progression of the elements 21a, 21b, 21c forms an acute angle with the progression of the dipole antenna, in other words runs transverse to the dipole antenna. The elements 21a, 21b, 21c are applied to the band substrate 10 made of a polymer material, for example PET, by means of printing technology, and are formed from a printing ink, for example, a so-called void structure ink.

The elements 21a, 21b, 21c of the void structure are covered by a top layer 22. The top layer 22 is situated above the elements 21a, 21b, 21c and above their top, and touches the band substrate 10 in the interstice between the elements 21a, 21b, 21c. The top layer 22 can also be imprinted on the band substrate 10 or the elements 21a, 21b, 21c as a printing ink, a so-called void overprint ink. Fundamentally, embodiments are also possible in which the top layer 22 or the void overprint ink is not present and is absent. Then, the antenna directly contacts the elements composed of void structure ink and the band substrate in the interstice between the elements of void structure ink, in each instance.

As shown in FIG. 2, the dipole antenna is above the void structure 20 in its region 33 shown on the left. An imaginary perpendicular line with regard to the substrate or with regard to the antenna intersects the substrate, one of the elements 21a, 21b, or 21c, the top layer 22, and the section 33 of the dipole antenna. In the section 30 of the dipole antenna shown on the right, the dipole antenna runs directly on the band substrate 10. It is practical if the dipole antenna is also applied by means of printing technology, as a conductive printing ink.

In the left region 33 of the band, above the void structure 20, an adhesive 23 is applied. The adhesive 23 serves for being able to glue the two ends together when the band has been laid around a body or is wound around it. It is practical and sufficient to provide adhesive only on one end or one half of the band. It is also possible that the entire band surface is provided with adhesive. In the exemplary embodiment shown, the surface of the band that extends from the left edge to beyond the transponder inlay 40 is coated with adhesive. The region that extends past that, farther to the right in the representation of FIGS. 1 and 2, does not carry any adhesive. It is practical if the surfaces with adhesive and the surface that is taken up by the void structure 20 have the same coverage or almost the same coverage.

As shown in FIG. 2, the transponder inlay 40 is inserted with the chip down, in other words with an orientation toward the band substrate 10, so that the inlay substrate 41, which can be formed from PET, is situated toward the top surface. In this connection, the transponder inlay 40 is embedded into the adhesive layer 23.

In another embodiment, shown in FIG. 3, the transponder inlay is represented with the reverse orientation, in that the inlay substrate 41 lies downward, in other words oriented in the direction toward the band substrate 10. Disposed above that is the primary loop antenna 42, and once again above that, in other words facing farthest away from the band substrate 10, is the semiconductor chip 43 of the transponder circuit. All the elements of the primary transponder oscillating circuit are covered by an additional adhesive layer 23a. In order to protect the semiconductor chip 43 from mechanical damage, a covering 44 made of a polymer material is provided, which covers all the elements of the primary oscillating circuit and the immediate vicinity that follows it.

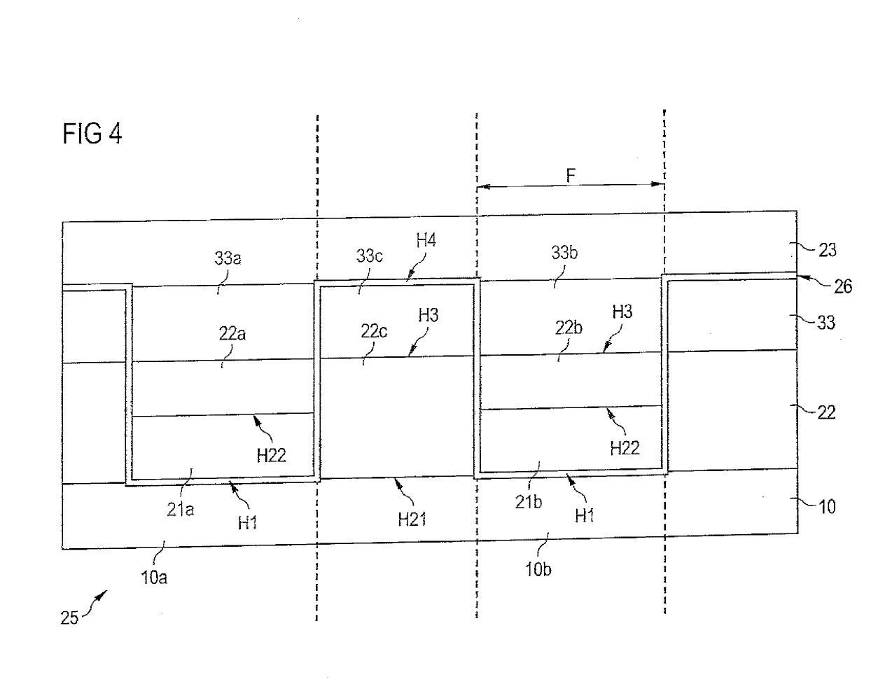

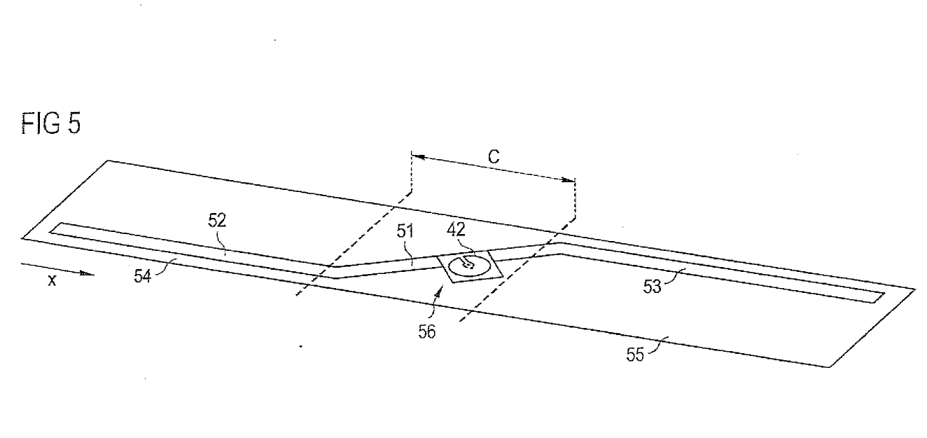

In FIG. 4, an enlarged detail 25 of the cross-sectional view shown in FIG. 2 is reproduced, in order to explain the adhesion forces of the different layers relative to one another using this view, and, resulting from this, to explain the desired function of the void structure in interaction with the other elements of the band. Fundamentally, the adhesion forces of the individual layers should be coordinated with one another, in such a manner that when the ends of the band have been glued together, and subsequently the band is torn open, part of the void structure remains adhering to the dipole antenna 33, on the one hand, and another part of the void structure remains adhering to the band substrate 10, on the other hand. In this way, the result is achieved that on the one hand, the dipole antenna 33 is interrupted, and the electrical function of the transponder is impaired, and, on the other hand, color contrasts occur due to the different printing inks used. Even if the band were glued together again in the correct position, it would be highly likely, on the one hand, that the electrical conductivity within the dipole antenna would remain interrupted, and, on the other hand, it would be highly likely that it would hardly be possible to bring the partial regions of the void structure that adhere to the different ends of the band together again in such a manner that the structure would have its complete original appearance again.

The elements made of void structure ink 21a, 21b, 21c act as an adhesion force adjustment agent, in that the adhesion force between void overprint ink 22 and band substrate 10, which is relatively high, in and of itself, is reduced in the region of the elements made of void structure ink 21a, 21b, 21c. The elements made of void structure ink 21a, 21b, 21c have a lesser adhesion to the band substrate 10 than the void overprint ink 22. In this way, the elements made of void structure ink bring about an effect of reducing the adhesion force, so that an ink layer separation effect is achieved in the void overprint ink 22. When the band is torn open, the void overprint ink 22 and the dipole antenna 33 are separated in accordance with the pattern of the elements of the void structure ink 21a, 21b, 21c.

In general, the relationship of the adhesion forces with which the elements made of the void structure ink adhere to the substrate, on the one hand, and with which the void overprint ink adheres to the dipole antenna, on the other hand, can be influenced in such a manner that in spots, the adhesion force of substrate and dipole antenna, at some points, is greater than that of substrate and dipole antenna, at other points, so that when dipole antenna and substrate are separated, the void overprint ink is separated in accordance with a specific pattern, so that part of the void overprint ink is connected with the substrate, and the remaining part is connected with the dipole antenna.

In detail, in the example of the embodiment shown, the void structure ink 21a, 21b has an adhesion force H1 relative to the band substrate 10 made of PET material. The void overprint ink 22 has an adhesion force H22 relative to the void structure ink elements 21a, 21b. The void overprint ink 22 furthermore has an adhesion force H21 relative to the band substrate 10. Finally, an adhesion force H3 exists between the printed dipole antenna 33 and the void overprint ink 22. An adhesion force H4 exists between the adhesive adhesive 23 and the printed dipole antenna 33. It is practical if the printed layers have a thickness of about 10 μm, and the longitudinal expanse F of an element 21a, 21b of the void structure ink has an expanse of about 1 mm in the cross-section shown.

Now the adhesion forces are adjusted as follows, which is possible by means of a suitable material selection of the printed elements:
adhesion force H1<adhesion force H4<one of the adhesion forces H21, H22, H3

With this relation of the adhesion forces, a parting line is formed along the line 26 if another substrate or the other end of the band is glued onto the adhesive adhesive 23 with great adhesion force, and the structure is pulled apart. This means that the void structure ink elements 21a, 21b tear off from the band substrate 10, with predominant likelihood, so that elements 33a, 33b of the dipole antenna 33 as well as 22a, 22b of the void overprint ink 22 remain adhering to the adhesive adhesive layer 23 together. On the other hand, the element 22c of the void overprint ink 22 as well as the element 33c of the dipole antenna 33 continue to remain adhering to the band substrate 10 in the region between the void structure ink elements 21a, 21b.

This brings about an optically recognizable void image, in that only the extensively transparent sections 10a, 10b of the band substrate 10 are visible in those locations where the void overprint ink 22 adheres to the adhesive 23, namely in the region of the void structure ink elements 21a, 21b, while the corresponding sections of the void overprint ink on the band substrate 10 remain visible in those locations where the void overprint ink sections 22c still remain adhering to the band substrate 10. In principle, the void overprint ink 22 could also be left out. If the void overprint ink 22 is present, the color contrast conditions are better recognizable.

In FIG. 5, another embodiment with a primary loop inlay is shown. In the change section 51, the dipole antenna runs essentially diagonal to the longitudinal expanse direction x of the band. In the section 52, the dipole antenna is disposed relatively close to the edge 54 of the band shown at the bottom. In section 53, the dipole antenna is disposed relatively close to the edge 55 of the band shown at the top. Between them is the change section 51 of the dipole antenna. Within this section 51 (covered), a loop 56 of the dipole antenna runs to form a circular section, if possible, above which the circular winding of the primary loop antenna 42 runs.

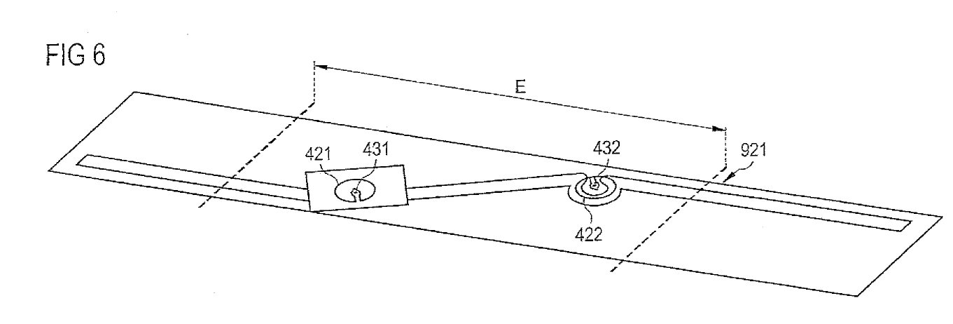

In FIG. 6, a transponder having more than one, namely two semiconductor chips is shown, which are coupled, in each instance, with the dipole antenna by way of a primary loop antenna 421 and 422, respectively. In this connection, the primary loop antennas, in each instance, lie over a corresponding loop of the dipole antenna, which loops are formed as a circular segment, for example, in order to couple reciprocally with one another, by means of an extensively magnetic active field.

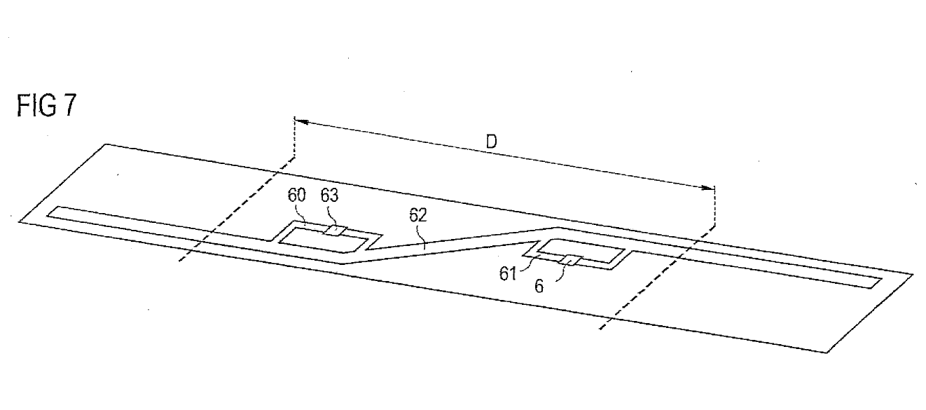

In FIG. 7, yet another embodiment is shown, in which the semiconductor chips, in contrast to FIG. 6, are coupled with the dipole antenna not by means of a loop antenna, but rather by way of an adaptation network 60, 61, in each instance. The adaptation networks are situated at the end of the change zone 62. For this purpose, a semiconductor chip 63, 64, in each instance, is connected to an adaptation network. The adaptation network is configured as a conductor tracks that run in U shape, to which the semiconductor chip is contacted. The ends of the U-shaped conductor tracks, in each instance, are connected with the dipole antenna.

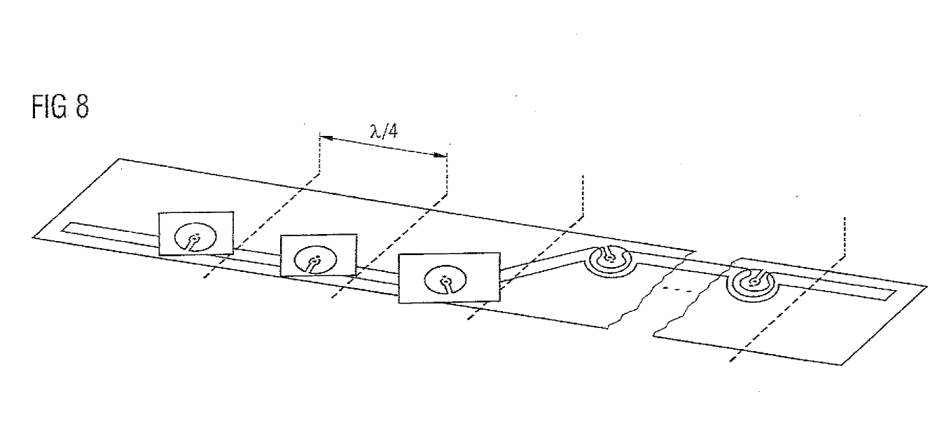

In FIG. 8, a band having a transponder circuit is shown, which has a plurality of semiconductor chips, which are coupled with the dipole antenna by way of a primary loop antenna, in each instance. It is practical if the semiconductor chips or the coupling-in points for the primary loop antennas are at a distance of λ/4 from one another, whereby λ amounts to the wavelength of the inherent frequency in the RFID oscillating circuit or in the dipole antenna of the band at an operating frequency of the system of about 900 MHz. In practice, the distance λ/4 between two semiconductor chips amounts to about 60 to 75 mm. This takes the dielectric influence of the substrate and the other components of the band into consideration, thereby reducing the wavelength on the basis of the dielectric influences of the overall assembly as compared with the wavelength that is theoretically present in a vacuum.

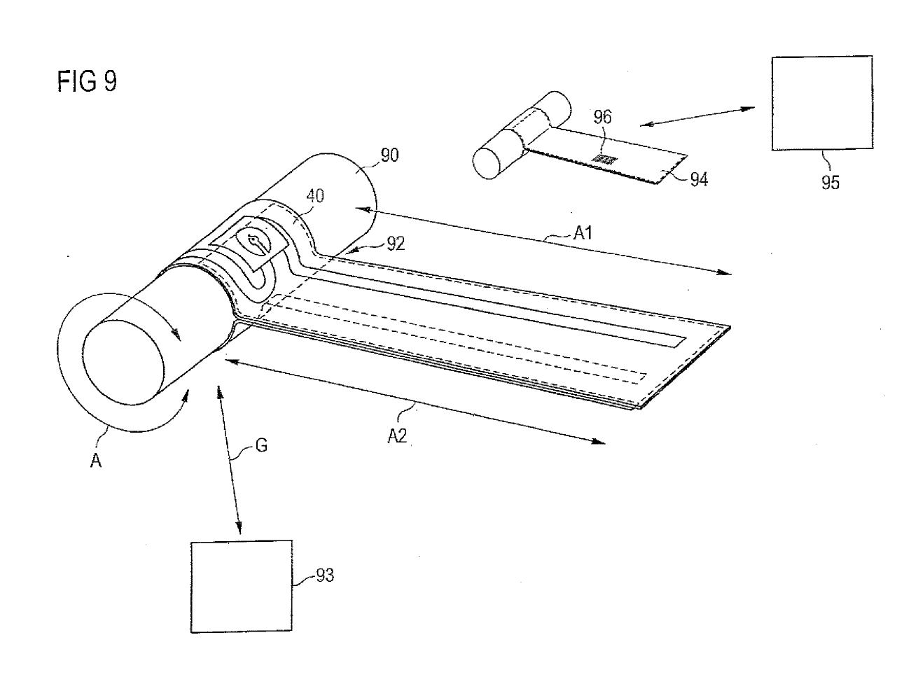

In FIG. 9, the use of a band according to the present embodiments is shown. The band is wound around a body 90. The body 90 is a round body, in the representation shown; other shapes are also possible. In practice, the body 90 could be the handle of a piece of luggage or another element on a piece of luggage. The central region A (see also FIG. 1) is wound around the body 90. In this connection, the length of the section A is approximately so large that it is extensively equal to the circumference of the body 90. Outside the section A, the two end-side sections A1, A2 of the band are glued to one another by means of the adhesive adhesive 23. The band thereby sits on the body 90 relatively securely. In particular, the transponder inlay 40 lies on the body.

If an improper attempt were now made to remove the band from the body 90, the following effects could occur. On the one hand, the sections A1, A2 could be loosened from one another, thereby causing the void effect described in connection with FIGS. 2 and 4 to become visible. Furthermore, with great likelihood, the dipole antenna would be interrupted in the region A1 as a result of the void effect, both at the end-side end of A1 and in the vicinity of the end 92 of the section A1 that is situated close to the body 90. The electrically active length of the antenna would thereby be reduced, so that electrical non-symmetry would occur after opening of the glued band, in place of the original transponder inlay 40 being disposed relatively in the center with regard to the longitudinal expanse of the dipole antenna.

Another improper manipulation could consist in that the band is cut with a cutting tool in the region 92. Then, too, the antenna would be interrupted in the region of the location 92, so that the electrically active length of the dipole would be reduced, and electrical non-symmetry would occur relative to the transponder inlay 40. At a typical operating frequency of 900 MHz, the dipole antenna has a typical length of 120 to 170 mm, taking into consideration the dielectric influences of the layers within the band, in other words the sections A, A1, and A2 in total amount to 120 to 170 mm in this case. It is practical, in practice, for the length of the dipole antenna to lie between 120 to 150 mm. About two-thirds (⅔) of the length of the band is available for the region A, so that the ends A1, A2 to be glued together each comprise about one-sixth (⅙) of the length, thereby achieving a significant drop in the reading range in the case of destruction of the dipole antenna in the region of the sections A1, A2, in each instance. If the inner section A comprises about ⅓ of the length of the band, and the outer sections A1, A2 ⅓ of the length of the band, in each instance, the drop in reading range or the contrast ratio between reading range in the undamaged state and the damaged state is still sufficiently increased, and can thereby be electronically determined.

If the band opened in this manner were now to be used elsewhere, this could be determined, by means of a reduction in the reading range, by a reader device that attempts to read data stored in the semiconductor chip of the RFID transponder. For example, a reader device 93 is situated at a distance G from the transponder, whereby the distance G in FIG. 9 is not shown to scale. Let the distance G be the maximal distance at which data transfer with the transponder is still possible. In the case of a dipole antenna damaged by triggering the void effect, the dipole antenna is no longer able to derive sufficient electrical energy from the electromagnetic field generated by the reader device 93. As a result, the reading range of a destroyed band decreases. At the size ratios described, for example operating frequency 900 MHz, length of the dipole antenna 120 to 150 mm, one-third of the length of the band wound around the body, a sensitivity loss occurs during access of the reader device 93 to the band, in which the ratio of the reading range of damaged/undamaged band lies between 1:2 to 1:10, but at least in the range of 1:5 to 1:10. This means that the maximal distance between the band and the reader device 93, at which the information programmed in the semiconductor chip of the transponder inlay 40 is still readable, is less, in the interrupted state, by a range of 2 to 10 times or 5 to 10 times than in the non-interrupted state of the dipole antenna of the band. If a reader device is adjusted, in a logistics process, for example in baggage handling of luggage at an airport, in such a manner that the information from bands of pieces of luggage passing by in the undamaged state is still possible, then a damaged band passing by can be recognized in that it can no longer be read by the reader device. The piece of luggage can be sorted out and be examined further manually. In this connection, the type of manipulation can be recognized by means of a triggered void effect.

In another application, the band can furthermore be combined, as shown in FIG. 9, with another band 94, which is coupled with the same piece of luggage. Optically readable information is found on the further band 94. This can be, for example, logistics information, such as flight number, flight destination, owner of the piece of luggage, etc., which is applied to the further band using alphanumeric symbols and/or a barcode 96. Now the optically readable information can be partly or completely stored in the semiconductor chip of the RFID transponder of the RFID band. If a further reader device 95 for optical recognition of the information 96 on the further band 94 is present in the logistics process, this optically detected information can be compared with the information detected by the RFID reader device 93. If it is found that the two information contents are the same, it can be assumed that the bands have not been replaced and that the RFID band has not been damaged. If it was found that the data of the two bands deviate from one another, this gives rise to further manually conducted inspections. The RFID band and the corresponding reader device 93 can easily be additionally integrated into the existing logistics process, which already makes use of reader device 95 and optical band 94.

A further application of the security tag or the band according to the present application is explained using FIG. 6. In this connection, the logistics data that are stored in one of the semiconductor chips of one of the transponder inlays, for example 431, are stored in the semiconductor chip of the other transponder inlay, for example 432, as a function of the data stored in the semiconductor chip 431. For example, the complete logistics data can be stored divided up, in other words partly in one of the semiconductor chips and partly in the other of the semiconductor chips, so that the complete logistics information is only obtained if the data can be completely read out from both chips. On the other hand, data that are stored in one semiconductor chip can also be stored in the other semiconductor chip, directly or by means of corresponding coding, so that when the two semiconductor chips are read out, the data can be compared with one another and it can be determined, as a function of this, whether the data can be completely read out from the two semiconductor chips. Furthermore, an identification marking of the chip 431 can be stored in the chip 432 and/or vice versa. If it is found that one of the identification markings of the chip that is no longer readable is absent, this indicates a damaged band.

If the band was damaged at the edge of the region E or outside the region E, for example, by means of a cutting tool or by triggering of the void effect, so that the antenna has been destroyed, then either both semiconductor chips are no longer completely readable or only one of the semiconductor chips is readable, while the other semiconductor chip is no longer readable. If, for example, the dipole antenna is interrupted at the location 921, the state could occur that because of the increased non-symmetry in the region of the loop antenna 422, the reading range is significantly reduced there, while although a certain non-symmetry is also present at the loop antenna 421, but the symmetry is still sufficient to read out the data from the semiconductor chip 431 that belongs to the loop antenna 421, due to a sufficient reading range. By means of a comparison of the data read out of the semiconductor chips 431, 432, it can be determined whether or not manipulation of the band has occurred.

Finally, the aforementioned measures of distributed storage of logistics data in multiple chips of the transponder circuit can also be correspondingly generalized and continued further using the embodiment shown in FIG. 8, in which a plurality of semiconductor chips are disposed at a distance of λ/4. In this case, the dipole antenna has a length that amounts to (n+1)*λ/4, whereby n is the number of primary transponders. In this connection, it is possible to monitor partial regions of the antenna for interruption, in the case of such an extended antenna. The primary transponder that is disposed closest to the interruption will be readable with greater difficulty or not at all, over greater distances, while the other transponders are still readable at the usual reading range. Such a band can be used if greater circumferences of a body must be secured.

1: Security tag, comprising:
a substrate layer (10);
a void structure (20) applied to the substrate layer;
an RFID transponder applied to the substrate layer (10), which comprises at least one semiconductor chip (43) and a dipole antenna (30).

2: Security tag according to claim 1, in which the dipole antenna (30) has a longitudinal expanse and the void structure comprises multiple elements (21a, 21b, 21c) disposed at a distance next to one another and a top layer (22), which is applied above the elements (21a, 21b, 21c) of the void structure and contacts the substrate layer (10) between the elements of the void structure, wherein the dipole antenna (30) contacts the top layer.

3: Security tag according to claim 2, in which the elements (21a, 21b, 21c) bring about the result that at certain points, an adhesion force between substrate layer (10) and dipole antenna (30), on the one hand, is greater than between substrate layer (10) and dipole antenna (30), on the other hand.

4: Security tag according to claim 2, in which an adhesive layer (23) is applied above the top layer (22), with which the security tag can be glued, in the region of a partial section (2) of the security tag, to another part of the security tag, in the region outside (1) the partial section.

5: Security tag according to claim 4, in which an adhesion force (H1) between one of the elements (21a, 21b, 21c) of the void structure and the substrate layer (10) is lower than an adhesion force (H4) between the dipole antenna (30) and the adhesive layer (23), and in which the aforementioned adhesion forces (H1, H4) in turn are lower than an adhesion force (H3) between the dipole antenna (30) and the top layer (22) or (H21) between the top layer (22) and the substrate layer (10) or (H22) between the top layer (22) and one of the elements of the void structure (21a, 21b, 21c).

6: Security tag according to claim 1, in which the void structure (20) is applied in a section (2) of the substrate layer (10) and contacts the dipole antenna (30) outside the section of the substrate layer (10), leaving out the void structure.

7: Security tag according to claim 1, in which the at least one semiconductor chip (43) of the RFID transponder is contacted to a loop antenna (42), which in turn is coupled with the dipole antenna (30) by means of an essentially magnetic active field.

8: Security tag according to claim 7, in which the RFID transponder comprises at least one further semiconductor chip (432), which is contacted to a loop antenna (422), which in turn is coupled with the dipole antenna by means of an electrical active field, wherein the dipole antenna in turn comprises a loop, in an overlapping region of loop antenna and dipole antenna.

9: Security tag according to claim 1, in which the RFID transponder comprises a first semiconductor chip (63) and at least a second semiconductor chip (64), which are each contacted to an adaptation network (60, 61), wherein each adaptation network is connected with a dipole antenna (62).

10: Security tag according to claim 8, in which, during operation, data that are stored in one of the semiconductor chips (431) of the RFID transponder are stored as a function of data stored in the other of the semiconductor chips (432) of the RFID transponder.

11: Security tag according to claim 1, in which the dipole antenna is designed to be able to receive an electromagnetic signal at a frequency having a predetermined wavelength λ, wherein a plurality of semiconductor chips are disposed distributed along the dipole antenna, and the length of a section of the dipole antenna between two adjacent semiconductor chips amounts to λ/4.

12: Assembly having a security tag according to claim 8, furthermore comprising a body (90) around the circumference surface of which the security tag is wound, wherein a part of the security tag between two adjacent ones of the semiconductor chips is dimensioned in such a manner that it lies on the circumference surface of the body and that further parts of the security tag outside the aforementioned part are glued to one another, at least in part.

13: Assembly according to claim 12, comprising a further tag (94) that is attached around bodies, wherein data that are applied to the further tag in optically readable manner are stored in at least one of the semiconductor chips.

14: Assembly according to claim 12, in which the dipole antenna of the security tag has a length, and the part of the security tag that lies on the circumference surface has at least one-third of the length.

15: Method for operation of a security tag according to claim 1, comprising:
making available a body (90);
affixing a means of identification (94) to the body (90), which means has optically readable information (96);
affixing the security tag to the body (90), in that a part (A) is wound around the body (90), and other parts (A1, A2) of the security tag that lie outside of the aforementioned part, are glued to one another, at least in part;
programming information that is dependent on the optically readable information (96) into the semiconductor chip of the security tag.

16: Method according to claim 15, in which the security tag is destroyed in that the dipole antenna is interrupted outside the part (A1, A2, 92) that is wound around the body (90), and in which the maximal distance (G) between the security tag and a reader device (93), at which the programmed information from the semiconductor chip of the security tag is still readable, is less, in the interrupted state, by a range of 2 to 10 times, preferably 5 to 10 times, than in the non-interrupted state.
